(19) United States
(12) Patent Application Publication
(10) Pub. No.: US 2008/0165119 A1
(43) Pub. Date: Jul. 10, 2008

(54) Active matrix with write memory

(76) Inventor: Chan-Long Shieh, Paradise Valley, AZ (US)

Correspondence Address: ROBERT A. PARSONS, 4000 N. CENTRAL AVENUE, SUITE 1220, PHOENIX, AZ, 85012, US

(21) Appl. No.: 11/650,148

(22) Filed: Jan. 5, 2007

(51) Int. Cl. G09G 3/34

(52) U.S. Cl. 345/107

(57) ABSTRACT

A display with memory includes an electrophoretic flat display panel with a common transparent conductive electrode positioned on a major viewing surface. An active matrix with an array of conductive pads is positioned on a reverse side of the panel and each conductive pad defines a pixel in conjunction with the common transparent conductive electrode. The active matrix includes conductive select lines and data lines. A common reset terminal is connected to the common transparent conductive electrode. A diode and a storage capacitor electrically couple each conductive pad to a data line and a select line, respectively, such that each conductive pad is separately addressable by a unique combination of select line and data line. Each of the conductive pads is electrically coupled to the common reset terminal by the intrinsic capacitance of the cell.

### FIELD OF THE INVENTION

This invention generally relates to an active matrix for flat panel displays and more specifically to write circuitry for active matrix displays.

### BACKGROUND OF THE INVENTION

There is a large variety of different types of displays presently used in the flat panel display field. Included among these different types are liquid crystal displays (LCDs), plasma displays, electroluminescent displays (ELDs), electrophoretic displays (EPDs), electrochromic displays (ECDs), etc. In general, each of these different types have somewhat different applications but may overlap and be competitive at the edges of a particular use or application. For example, plasma displays are used in large television monitors while LCDs are becoming more adaptable to mid-range monitors. Generally, LCDs are widely used in small displays, such as telephones, hand-held devices and the like.

New classes of display technologies have been developed to exhibit memory characteristics, i.e. when an applied voltage is removed from a pixel the state of the pixel remains the same. Electrophoretic materials include particles that move through or rotate within a suspending material. Electrophoretic displays (EPDs) change color and reflectivity based on charged moving particles. One major advantage of EPDs is the low manufacturing cost due to high production throughput associated with the use of flexible substrates. To take advantage of this low cost display technology, it is essential that the driving or controlling circuitry is also low cost.

One EPD material that is used as an example in the present application is one in which charged particles move within a layer of suspending material to one surface or the other when an electric field of a specific polarity is applied across the layer. In a typical example, the particles are white colored and positively charged so that they are drawn to a surface having a negative voltage applied relative to the opposed surface. In this example, the material appears to turn white when the relative negative voltage is applied to the viewing surface.

Once the particles are attracted to the surface by the negative voltage, they remain adjacent to the surface even when the negative voltage is removed. This is referred to as having a memory. Even Brownian movement appears to have little or no effect on the particles. Further, as an example, the suspending material can be light absorbing so that when the white particles are drawn away from the surface, i.e. by applying a positive voltage to the viewing surface and a negative voltage to the opposed surface, the material appears to be dark or with different colors, depending on the absorbing spectrum of the suspending material. Therefore, a display is produced by providing electrodes on opposite sides of an array of electrophoretic cells and activating the electrodes to cause each of the cells to be light or dark or to change color.

In the prior art, one of the main types of electrophoretic displays includes the use of a segmented drive, i.e. no active matrix. This particular arrangement is only useful for very small displays having few pixels. When a display incorporating a large number of pixels is desired, the segmented drive becomes extremely complicated and, therefore, extremely costly. Similarly, a passive matrix, while it is the simplest and cheapest to fabricate, is not an option for large displays because of the crosstalk. The problem is the fact that a threshold voltage at which the switching of electrophoretic material begins normally lies anywhere in a broad range and can vary substantially with temperature. This characteristic eliminates a passive matrix as a potential embodiment.

Another type of electrophoretic display used in the prior art is an active matrix using thin film transistors (TFTs). This structure has been primarily copied from the liquid crystal (LCD) field. In the typical embodiment, a common electrode is supplied on one surface of the electrophoretic material (i.e. the viewing side) and an electrode with a thin film transistor (TFT) attached is supplied on the other side. A TFT is a complicated device and its fabrication cost is high relative to EPDS. For a TFT active matrix associated with EPDs, the dominant cost is in the TFT backplane

One way to reduce the cost of the backplane is to implement active matrices using much simpler thin film diodes. However, two major problems arise. In all such active matrices, the thin film diodes must be bidirectional, i.e. essentially two diodes in parallel oriented with opposite polarities. Usually, the full voltage required to switch electrophoretic material from one state to the other is relatively large. Depending upon the specific construction and the materials used, the voltage required to switch a cell to light from dark or to dark from light can be tens of volts, e.g. from ten to eighty volts. For this TFD switching circuit to operate correctly, the turn-on voltage of the bidirectional diode must be much greater than the full switching voltage of the electrophoretic material. Thus, an active matrix using bidirectional TFDs would require a very large operating voltage that would make the cost of drivers prohibitive.

A major disadvantage of writing directly to the active matrix is the limited speed in writing to each EPD in each line. The writing is done one line at a time without memory. The speed of writing a line is dictated by the speed of the EPD which is on the order of 100 ms or more. Therefore, the line time window is controlled by the response time of the EPD. The frame time is determined by multiplying the line time by the number of lines. To write a display with hundreds of lines, the frame time is too long (up to minutes). While this might be satisfactory for some applications, many applications require a much faster write time.

It would be highly advantageous, therefore, to remedy the foregoing and other deficiencies inherent in the prior art.

Accordingly, it is an object of the present invention to provide a new and improved active matrix for flat panel displays of various types with a much faster write time.

### SUMMARY OF THE INVENTION

Briefly, to achieve the desired objects of the instant invention in accordance with a preferred embodiment thereof, provided is a display with memory that includes an electrophoretic flat display panel with a common transparent conductive electrode positioned on a major viewing surface. An active matrix with an array of conductive pads is positioned on a reverse side of the panel and each conductive pad defines a pixel in conjunction with the common transparent conductive electrode. The active matrix includes conductive select lines and data lines. A diode and a storage capacitor electrically couple each conductive pad to a data line and a select line, respectively, such that each conductive pad is separately addressable by a unique combination of select line and data line. Each of the conductive pads is electrically coupled to a common reset terminal, which in this embodiment is the common transparent conductive electrode, by the intrinsic capacitance of the cell.

The desired objects of the instant invention and others are further achieved through a method of writing data to an electrophoretic flat panel display with memory including the step of providing an electrophoretic flat display panel including an active matrix with an array of conductive pads positioned on the reverse side of the flat display panel so that each conductive pad defines a pixel in conjunction with a common transparent conductive electrode positioned on the major viewing surface. In the provided panel, the active matrix includes select lines and data lines with a data input diode and a storage capacitor connecting each conductive pad to one of the data lines and to one of the select lines, respectively, such that each pixel is separately addressable by a unique combination of select line and data line. The method further includes a step of resetting all of the pixels initially into a dark state by applying a V_{EPD}+Vₒₙ signal to the reset terminal (the common transparent conductive electrode), a signal equal to zero volts to all select lines, and a Vₒₙ signal to all data lines, where V_{EPD} is a voltage required to change states of the pixel and Vₒₙ is the turn on voltage of the data input diode. The method further includes a step of writing data into the storage capacitor of a selected pixel by applying a zero voltage signal on the select line of the selected pixel, applying a signal equal to V_{EPD}+Vₒₙ to all select lines of pixels not selected, retaining a signal equal to Vₒₙ+V_{EPD} on the reset terminal, and applying a signal to the data line equal to a voltage between Vₒₙ and V_{EPD}+Vₒₙ representative of a desired brightness.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified exploded view in perspective of an embodiment of a flat panel display including electrophoretic cells and thin film diode active matrix with write memory in accordance with the present invention;

FIG. 2 is an enlarged portion of a small area of FIG. 1;

FIG. 3 illustrates a voltage-switching or response curve for a typical electrophoretic cell;

FIG. 4 illustrates an I-V graph for a typical diode used in the active matrix of FIG. 1;

FIG. 5 is a schematic drawing of a cell similar to the cell illustrated in FIG. 2;

FIG. 6 is a voltage table illustrating the voltages on the nodes of the schematic drawing of FIG. 5 during various states of operation;

FIG. 7 is a simplified exploded view in perspective of another embodiment of a flat panel display including electrophoretic cells and thin film diode active matrix with write memory in accordance with the present invention;

FIG. 8 is an enlarged portion of a small area of FIG. 7;

FIG. 9 is a schematic drawing of a cell similar to the cell illustrated in FIG. 8; and

FIG. 10 is a voltage table illustrating the voltages on the nodes of the schematic drawing of FIG. 7 during various states of operation.

### DETAILED DESCRIPTION OF A PREFERRED EMBODIMENT

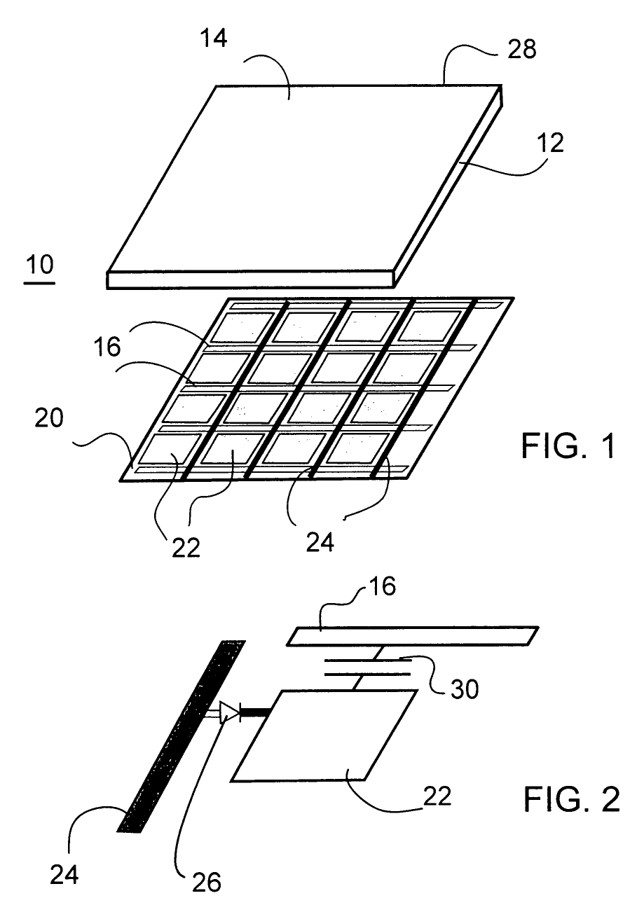

Turning now to the drawings, attention is first directed to FIGS. 1 and 2, which illustrate a simplified exploded view in perspective of a flat panel display 10 and an enlarged portion thereof, respectively. Display 10 includes a display panel 12, which is an array of electrophoretic cells 14. Here it will be understood that cells 14 can be formed as a plurality of individual or unitary cells distributed in rows and columns, elongated cells can be divided into rows or columns, or the entire panel 12 can be formed as a single unit with the control matrix separating it into smaller cells or areas.

A backplane 20 is laminated to the rear surface of panel 12 and contains an active matrix including an array of conductive pads 22. Data lines 24 extend vertically between adjacent columns of conductive pads 22, with one data line 24 for each column of conductive pads 22, and select lines 26 extend horizontally between adjacent rows of conductive pads 22, with one select line for each row of conductive pads 22. It will of course be understood that there is no connection between data lines 24 and select lines 26 on the surface of panel 20. Also, it should be understood that the positions of the select lines and data lines are for purposes of this explanation and that the lines could be reversed or positioned differently if desired. Each conductive pad 22 is connected to one data line 24 of the plurality of vertically extending data lines 24 by a thin film diode 26, as illustrated in FIG. 2. Each conductive pad 22 is connected to one select line 16 of the plurality of horizontally extending select lines 16 by a storage capacitor 30, as illustrated in FIG. 2.

A common transparent conductive plane 28 is deposited on the upper or visible surface of display panel 12. Because conductive plane 28 is common, no alignment of cells and backplane 20 is required during manufacture. Thus, manufacturing is greatly simplified since there are no electrical connections between display panel 12 and backplane 20 and no critical alignment is necessary. For example, display panel 12 and backplane 20 could be manufactured separately and laminated together later or backplane 20 could be formed directly on the back of display 12. It will be understood from the following description that backplane 20 can be formed using virtually any convenient material as a substrate. For example, the substrate can include glass, quartz, silicon, PCB, PET, polyimide (PI), aluminum foil, SS foil, etc.

Display 10 includes m horizontal select lines 16 and n vertical data lines 24 cooperating to divide panel 12 into an array of m×n pixels or cells each including one of the m×n conductive pads 22. As is understood in the art, each pixel or cell is addressed (or selected) through the specific select line 16 and the data line 24 connected to the specific conductive pad 22 on the lower surface. Further, by applying a predetermined voltage to the specific conductive pad 22 the selected cell or pixel can be switched into a dark or light state as will be explained in more detail below.

It will be understood that the driver circuitry includes additional circuits (not shown) which are designed to select cells or pixels in some predetermined order and to apply preselected driving voltages in accordance with some selected data to be displayed. These additional circuits are well known in the art and are dependent upon specific applications so that further disclosure is not necessary to the understanding of the present invention and, therefore, will not be undertaken herein.

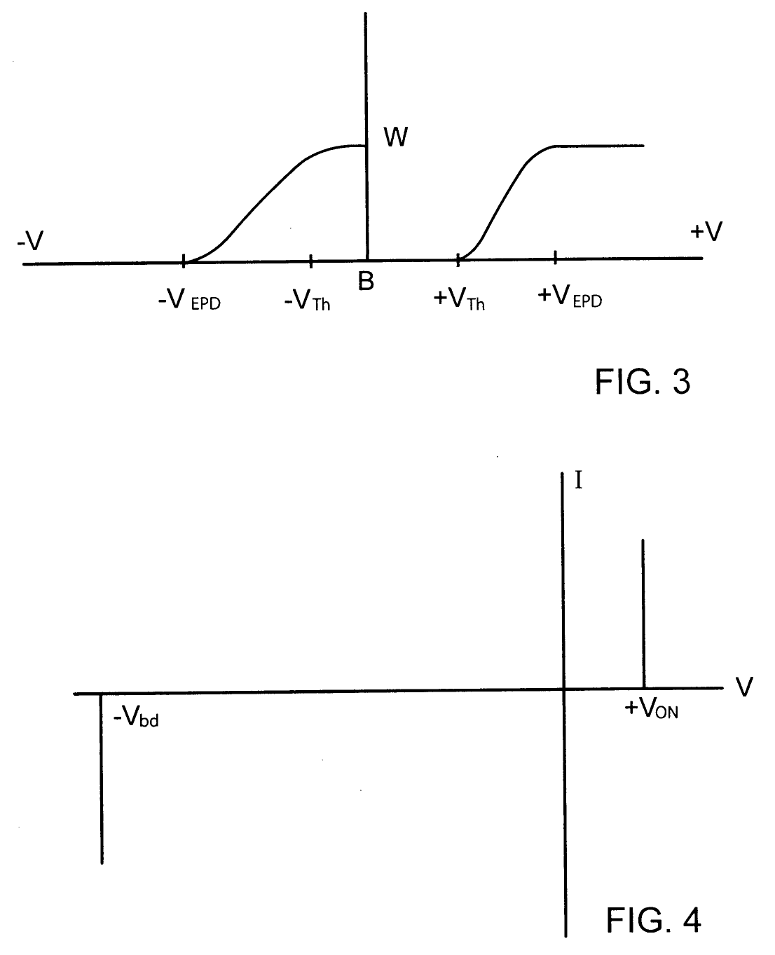

Referring additionally to FIG. 3, a response curve for typical electrophoretic material used in cells 14 is illustrated. As can be seen, at some threshold voltage greater than zero, herein designated +Vₜₕ, light particles begin to be attracted toward the visible surface of a cell. When the applied voltage reaches +V_{EPD}, sufficient particles are attracted toward the visible surface to switch the cell from dark to light, i.e. switch operating modes. Similarly, at some threshold voltage less than zero, herein designated −Vₜₕ, light particles begin to be attracted toward the rear surface of a cell and when the applied voltage reaches −V_{EPD}, sufficient particles are attracted toward the rear surface to switch the cell from light to dark, i.e. switch operating modes. It should be understood that a specific electrophoretic material is described here that requires a positive voltage to turn it light. However, in electrophoretic displays and the like the material can be reversed or modified so that the opposite effect occurs or an opposite voltage is required to switch from dark to light and vise versa.

Here it should be understood that any voltages applied to the cell which lie between −Vₜₕ and +Vₜₕ have no visible effect on the cell (i.e. no change in brightness). This area of operation is responsible for the memory in electrophoretic cells. Also, one of the major problems with the use of electrophoretic materials is the fact that the exact position or voltage of −Vₜₕ and +Vₜₕ can vary substantially (i.e. as much as a volt), depending upon the electrophoretic material used and the temperature during operation.

Storage capacitors 30 are relatively large and may, for example, be deposited under the reverse side of each conductive pad 22. This is easily accomplished by depositing a first plate for each capacitor on the surface of backplane 20, depositing a dielectric layer on the first plate, and then depositing conductive pad 22 over the dielectric. In this fashion storage capacitor 30 is automatically connected to conductive pad 22 and only a connection between select line 16 and the first plate is required. Here it will be noted, the intrinsic capacitance of the cell 14, herein designated 32 (and referred to in the text below as C_{EPD}) is a relatively small capacitance between each conductive pad 22 and conductive plane 28. It is well known that the intrinsic capacitance of the electrophoretic cell C_{EPD} is very small because of the relatively thick electrophoretic material in display panel 12 and, therefore, cannot be used as a storage capacitance. Also, the capacitance of storage capacitor 30, herein designated Cₛₜ, is more than ten times greater than the capacitance of diode 26 and preferably greater than twenty times as much.

A current-voltage curve for thin film diode 26 in active matrix 10 is illustrated in FIG. 4. As is known, the amplitude of the reverse breakdown voltage −V_{bd} is generally much greater than the voltage required to reach +Vₒₙ (turn-on voltage). In this preferred embodiment, the voltage required to turn diode 26 on is approximately two volts, i.e., Vₒₙ equals approximately 2V. It is important that the reverse breakdown voltage −V_{bd} of thin film diode 26 is relatively large to withstand the voltage applied when the cell is switched from a selected mode to an unselected mode. Further, information on the reverse breakdown voltage −V_{bd} of diode 26 is included below. One way to achieve the relatively high reverse breakdown voltages required is to connect two to several diodes in series. Diodes in series not only increase the total reverse breakdown but reduce the diode capacitance at the price of increasing Vₒₙ proportionally.

In a preferred embodiment, diode 26, which is an asymmetric diode as explained above, is a printed diode such as Ta/TaO₂. Printed diodes can be fabricated on flexible substrates and are very convenient to manufacture. Also, printed diodes can be conveniently implemented in series by fabricating and connecting multiple diodes laterally or vertically. As an example, multiple diodes can be fabricated vertically by simply printing extra layers of materials. Printed diodes and the fabrication of flat panel displays is discussed in detail in copending United States Patent Application entitled “TFD Active Matrix”, bearing patent application Ser. No. 11/430,075, filed on May 8, 2005, and incorporated herein by reference. Also, it is well known in the art that diodes, such as the thin film diodes discussed herein, have an inherent capacitance.

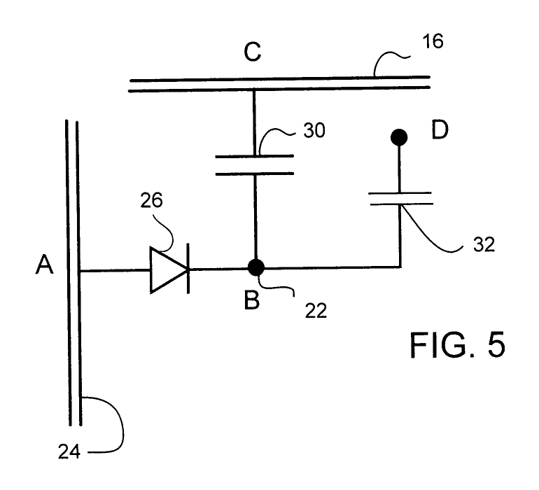

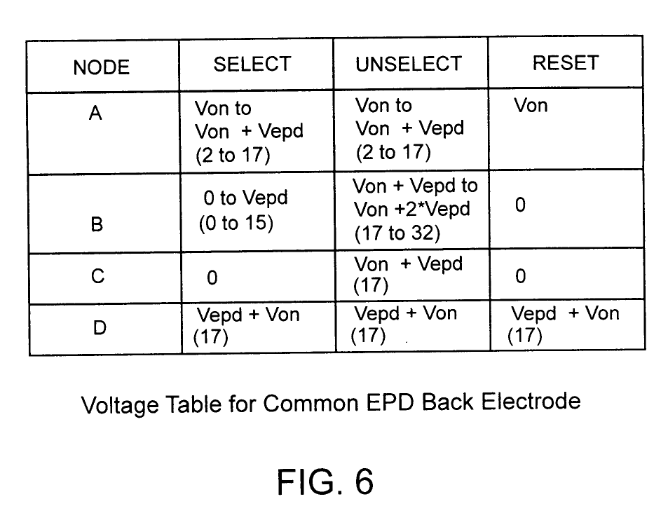

To understand the operation more fully, a schematic drawing of a cell 14 is illustrated in FIG. 5 with data line 24 designated node A, conductive pad 22 designated node B, select line 16 designated node C, and common conductive plane 28 designated node D. Common conductive pad 28 is used in this embodiment as a common reset input, as will be understood from the discussion below. In an exemplary embodiment, Vₒₙ is equal to 2 volts and V_{EPD} is equal to 15 volts so that V_{bd} of diode 26 is much larger than 32 volts. A voltage table is illustrated in FIG. 6 to further clarify the voltages on the various nodes during the various states of the operation. In the operation of display 10 and using the exemplary voltages, all of the cells 14 are reset initially into the black state by setting conductive plate 28 (node D) to V_{EPD}+Vₒₙ (17 volts), all select lines 16 (node C) to zero volts, and all data lines 24 (node A) to Vₒₙ (2 volts). Storage capacitor 32 (node B) will be at zero volts and cell 14 will be in the dark state as the voltage on it is at −(V_{EPD}+Vₒₙ) or −17 volts.

After the reset, all lines are unselected by holding the voltage on the rows or select lines 16 at V_{EPD}+Vₒₙ (17 volts). The voltage at node B (the inner terminal of storage capacitor 30) is raised to V_{EPD}+Vₒₙ (17 volts) and the voltage across cell 14 is now zero, which holds cell 14 in the dark state of the reset.

Data is written into storage capacitor 30 by a column driver on data line 24 (node A). Select line 16 (node C) of the cell being written is at zero volts and all unselected lines are maintained at V_{EPD}+Vₒₙ (17 volts). Also, common conductive plane 28 (node D) is maintained at V_{EPD}+Vₒₙ (17 volts). The data on data line 24 (node A) is between Vₒₙ (2 volts and a dark cell) and V_{EPD}+Vₒₙ (17 volts and a bright cell). Thus, storage capacitor 30 of the selected cell is charged very rapidly to the write voltage on data line 24. For all unselected cells, the voltage on select lines 16 (node C) is at V_{EPD}+Vₒₙ (17 volts) and diode 26 is reverse biased so that the voltage on storage capacitor 30 is not affected (since the capacitance of diode 26 is much smaller than storage capacitor 30). Thus, data can be written to the various cells at a very high rate because the voltage can be written at a very high rate and the voltage on each of the cells is maintained after the cell is no longer on a selected line. The rate of writing is limited by the charging capacity of diode 26 instead of the response time of the cell 14.

After the writing process, the voltage across storage capacitor 30 is between 0 volts and V_{EPD} volts, depending on the written data (desired state or brightness of the cell). But, as the voltage on select line 16 changes from 0 volts to V_{EPD}+Vₒₙ, as select line 16 changes from a selected cell to an unselected cell, the voltage on the inner node of storage capacitor 30 (node B) becomes V_{EPD}+Vₒₙ or 2V_{EPD}+Vₒₙ, depending on the written data, and the voltage across cell 14 becomes zero or V_{EPD}, depending on the written data. Thus, the written data is actually applied to cell 14 after the cell is changed to an unselected cell.

Referring additionally to FIG. 6, a chart illustrating the driving voltages present during the select and unselect stages of operation is included. From the chart in FIG. 6 and the above description of operation it will be understood that up to Vₒₙ+2V_{EPD} (in the specific example, 32 volts) can be applied across diode 26 during the unselect portion of operation. Thus, diode 26 is specifically selected to have a reverse breakdown voltage −V_{bd} of at least Vₒₙ+2V_{EPD} (in the specific example, 32 volts).

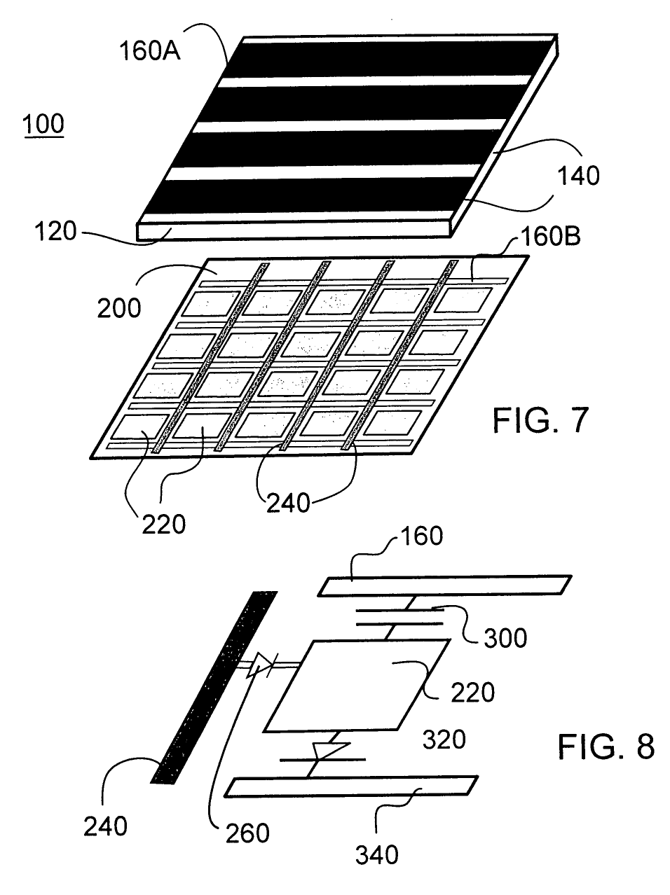

Turning now to FIGS. 7 and 8, a simplified exploded view in perspective of another embodiment of a flat panel display 100 and an enlarged portion thereof, respectively, are illustrated. Display 100 includes a display panel 120, which is an array of electrophoretic cells 140 divided into horizontal rows by a plurality of select lines 160A. Here it will be understood that cells 140 can be formed as a plurality of individual or unitary cells distributed in rows and columns, elongated cells can be divided into rows or columns, or the entire display panel 120 can be formed as a single unit with the select lines 160A and the control matrix separating it into smaller cells or areas.

A backplane 200 is laminated to the rear surface of display panel 120 and contains an active matrix including an array of conductive pads 220. Select lines 160B extend horizontally between adjacent rows of conductive pads 220, with one data line 160B for each row of conductive pads 220. Select lines 160B on backplane 200 are electrically connected to select lines 160A on display panel 120 and are hereinafter referred to generally as select lines 160. Data lines 240 extend vertically between adjacent columns of conductive pads 220, with one data line 240 for each column of conductive pads 220. Also, display panel 120 and backplane 200 are aligned so that the relatively broad select lines 160A are positioned generally in overlying relationship to rows of conductive pads 220, with one select line 160A for each row of conductive pads 220. Thus, the combination of conductive pads 220, select lines 160, and data lines 240 divide display panel 120 into rows and columns of cells or pixels.

It should be understood that the positions of the select lines and data lines are for purposes of this explanation and that the lines could be reversed or positioned differently if desired. Display panel 120 and backplane 200 could be manufactured separately and laminated together later or backplane 200 could be formed directly on the back of display 120. It will be understood from the following description that backplane 200 can be formed using virtually any convenient material as a substrate, for example, the substrate can include glass, quartz, silicon, PCB, PET, polyimide (PI), aluminum foil, SS foil, etc.

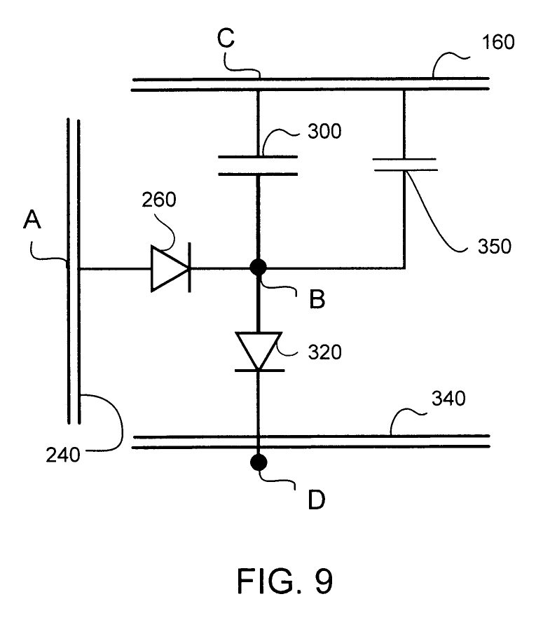

Each conductive pad 220 is connected to one data line 240 of the plurality of vertically extending data lines 240 by a thin film diode 260, as illustrated in FIG. 8. Each conductive pad 220 is connected to one select line 160 of the plurality of horizontally extending select lines 160 by a storage capacitor 300, as illustrated in FIG. 8. Also, a reset diode 320 has the anode connected to conductive pad 220 and the cathode connected to a common reset line 340. Here it should be noted that all reset diodes 320 (one connected to each conductive pad 220 in the array) are connected to common reset line 340. Also, the broad select lines 160A on the front face of display panel 120 and the conductive pads 220 produce the relatively small intrinsic capacitance, designated 350, which is in parallel with storage capacitor 300 (see FIG. 9).

Display 100 includes m horizontal select lines 160 and n vertical data lines 240 cooperating to divide panel 120 into an array of m×n pixels or cells each including one of the m×n conductive pads 220. As is understood in the art, each pixel or cell is addressed (or selected) through the specific select line 160 and the data line 240 connected to the specific conductive pad 220 on the lower surface. Further, by applying a predetermined voltage to the specific conductive pad 220 the selected cell or pixel can be switched into a dark or light state as will be explained in more detail below.

It will be understood that the driver circuitry includes additional circuits (not shown) which are designed to select cells or pixels in some predetermined order and to apply preselected driving voltages in accordance with some selected data to be displayed. These additional circuits are well known in the art and are dependent upon specific applications so that further disclosure is not necessary to the understanding of the present invention and, therefore, will not be undertaken herein.

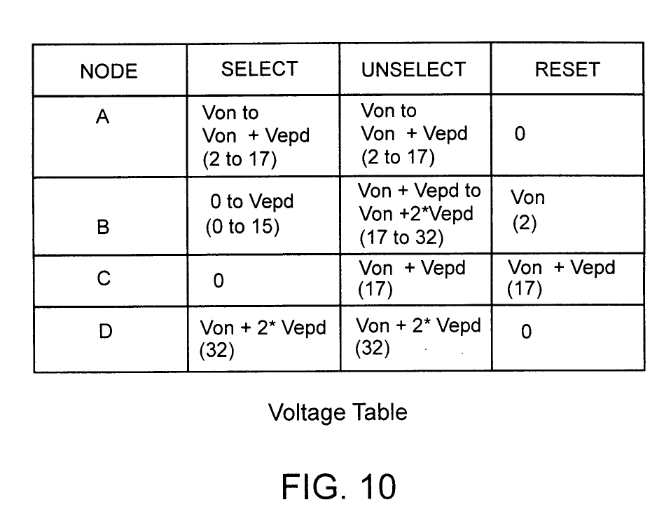

To understand the operation of this embodiment more fully, a schematic drawing of a cell 140 is illustrated in FIG. 9 with data line 240 designated node A, conductive pad 220 designated node B, select line 160 designated node C, and the common reset line designated node D. In an exemplary embodiment, Vₒₙ is equal to 2 volts and V_{EPD} is equal to 15 volts so that V_{bd} of diode 260 is larger than approximately 32 volts. A voltage table is illustrated in FIG. 10 to further clarify the voltages on the various nodes during the various states of the operation. In the operation of display 100 and using the exemplary voltages, all of the cells 140 are reset initially into the black state by setting reset line 340 (node D) to zero volts, all select lines 160 (node C) to V_{EPD}+Vₒₙ (17 volts) and all data lines 240 (node A) to Vₒₙ (2 volts). Storage capacitor 320 will be at −V_{EPD} and cell 140 will be in the dark state.

After the reset, storage capacitor 300 can be optionally charged to zero volts by setting all select lines 160 to zero volts and all data lines 240 to Vₒₙ or 2 volts. Setting the charge on all of the storage capacitors 300 at zero volts can further decrease the time required to write data into display 100 and simplify the data being written.

Data is written into storage capacitor 300 by the column driver represented by data line 240. In the select stage or mode, the voltage on the select line 160 (node C) of the cell being written or selected is at zero volts and all other select lines 160 (node C) of the cells not selected are at V_{EPD}+Vₒₙ (17 volts) and the reset voltage (node D) is at Vₒₙ+2V_{EPD}. The voltage on data line 160 (node A) is between Vₒₙ (dark) and V_{EPD}+Vₒₙ (bright). The voltage on storage capacitor 300 is quickly raised to the selected voltage (between Vₒₙ and V_{EPD}+Vₒₙ) that is present at node A and the associated pixel or cell ultimately rises to the selected voltage from 0 volts to V_{EPD} (dark to bright). For pixels not on the select line (unselected), the row voltage (node C) is at Vₒₙ+V_{EPD}, both diodes 260 and 320 are reverse biased and the voltage at the storage capacitor 300 is not affected if the capacitance of the diode 260 and 320 is much smaller than the capacitance of storage capacitor 300.

Because the RC time is very short for the large storage capacitor, the write time is very short. Thus, data can be written to display 100 at a very high rate because the voltage can be written at a very high rate and the voltage on each electrophoretic cell 140 is maintained when the pixel is not on the select line. The rate of writing in display 100 is limited by the charging capacity of diode 260 instead of the response time of the electrophoretic cells 140. Here it will be noted, the On/Off ratio of display 100 is greater than 10N, where N is the number of scan lines in the display.

Referring additionally to FIG. 10, a chart illustrating the driving voltages present during the select and unselect stages of operation is included. From the chart in FIG. 10 and the above description of operation it will be understood that up to Vₒₙ+2V_{EPD} (in the specific example, 32 volts) can be applied across diode 260 during the unselect portion of operation. Thus, diode 260 is specifically selected to have a reverse breakdown voltage −V_{bd} of at least Vₒₙ+2V_{EPD} (in the specific example, 32 volts).

Thus, two embodiments of a new and novel active matrix with write memory for a flat panel display have been disclosed. The active matrix with memory is especially useful and convenient when using electrophoretic material in the display panel. The write time is substantially reduced so that data can be written to relatively large display panels in relatively short times. Also, the preferred embodiment incorporates only one diode (a data input diode) in each pixel which substantially improves the fabrication process. While a specific polarity of diodes and signals is illustrated in the figures for purposes of explanation, it will be understood that the polarity of components and signals can be easily reversed if desired.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A flat panel display with memory comprising:
an electrophoretic flat display panel having a major viewing surface and a reverse surface, a common transparent conductive electrode positioned on the major viewing surface of the flat display panel;
an active matrix including an array of conductive pads positioned on the reverse side of the flat display panel with each conductive pad defining a pixel in conjunction with the common transparent conductive electrode positioned on the major viewing surface;
the active matrix including a plurality of conductive select lines and a plurality of conductive data lines;
a plurality of diodes and a plurality of storage capacitors; and
each conductive pad of the plurality of conductive pads being electrically coupled to one of the plurality of select lines by a storage capacitor of the plurality of storage capacitors and to one of the data lines by a diode of the plurality of diodes such that each conductive pad is separately addressable by a unique combination of select line and data line.

2. A flat panel display as claimed in claim 1 further including a common reset input terminal coupled to the common transparent conductive electrode.

3. A flat panel display as claimed in claim 1 wherein each diode of the plurality of diodes has a capacitance and each storage capacitor of the plurality of storage capacitors has a capacitance greater than ten times the capacitance of each diode.

4. A flat panel display as claimed in claim 3 wherein each storage capacitor of the plurality of storage capacitors has a capacitance greater than twenty times the capacitance of each diode.

5. A flat panel display as claimed in claim 3 wherein each data input diode of the plurality of data input diodes includes a plurality of thin film diodes connected in series.

6. A flat panel display as claimed in claim 1 wherein each diode of the plurality of diodes has a reverse breakdown voltage greater than a turn-on voltage of each diode plus twice a voltage required to change the mode of each pixel in the array.

7. A flat panel display as claimed in claim 1 wherein each storage capacitor in each pixel is positioned on a reverse side of the conductive pad in each pixel.

8. A flat panel display as claimed in claim 1 wherein the common transparent conductive electrode, the electrophoretic flat display panel, and the conductive pad of each pixel forms an electrophoretic capacitance and each storage capacitor in each pixel is larger than the electrophoretic capacitance of each pixel.

9. A flat panel display as claimed in claim 1 wherein the active matrix is positioned on a substrate including one of glass, quartz, silicon, PCB, PET, polyimide (PI), aluminum foil, and stainless steel foil.

10. A flat panel display with memory comprising:
an electrophoretic flat display panel having a major viewing surface and a reverse surface, a common transparent conductive electrode positioned on the major viewing surface of the flat display panel;
an active matrix including an array of conductive pads positioned on the reverse side of the flat display panel with each conductive pad defining a pixel in conjunction with the common transparent conductive electrode positioned on the major viewing surface;
the active matrix including a plurality of conductive select lines, a plurality of conductive data lines, and a common reset terminal coupled to the common transparent conductive electrode;
a plurality of data input diodes and a plurality of storage capacitors; and
each conductive pad of the plurality of conductive pads being electrically coupled to one of the plurality of select lines by a storage capacitor of the plurality of storage capacitors and to one of the data lines by a data input diode of the plurality of data input diodes such that each conductive pad is separately addressable by a unique combination of select line and data line, and each of the conductive pads of the plurality of conductive pads being electrically coupled to the common reset terminal.

11. A flat panel display as claimed in claim 9 wherein each data input diode of the plurality of data input diodes has a capacitance and each storage capacitor of the plurality of storage capacitors has a capacitance greater than ten times the capacitance of each data input diode.

12. A flat panel display as claimed in claim 11 wherein each data input diode of the plurality of data input diodes includes a plurality of thin film diodes connected in series.

13. A flat panel display as claimed in claim 11 wherein each storage capacitor of the plurality of storage capacitors has a capacitance greater than twenty times the capacitance of each data input diode.

14. A flat panel display as claimed in claim 10 wherein each data input diode of the plurality of data input diodes has a reverse breakdown voltage greater than a turn-on voltage of each data input diode plus twice a voltage required to change the mode of each pixel in the array.

15. A flat panel display as claimed in claim 10 wherein each storage capacitor in each pixel is positioned on a reverse side of the conductive pad in each pixel.

16. A flat panel display as claimed in claim 10 wherein the common transparent conductive electrode, the electrophoretic flat display panel, and the conductive pad of each pixel forms an electrophoretic capacitance and each storage capacitor in each pixel is larger than the electrophoretic capacitance of each pixel.

17. A flat panel display with memory comprising:
an electrophoretic flat display panel having a major viewing surface and a reverse surface, a plurality of conductive select lines positioned on the flat display panel;
an active matrix including an array of conductive pads positioned on the reverse side of the flat display panel with each conductive pad defining a pixel in conjunction with the electrophoretic flat display panel;
the active matrix including a plurality of conductive data lines and a common reset terminal;
a plurality of data input diodes, a plurality of reset diodes, and a plurality of storage capacitors; and
each conductive pad of the plurality of conductive pads being electrically coupled to one of the plurality of select lines by a storage capacitor of the plurality of storage capacitors and to one of the data lines by a data input diode of the plurality of data input diodes such that each conductive pad is separately addressable by a unique combination of select line and data line, and each of the conductive pads of the plurality of conductive pads being electrically coupled to the common reset terminal by a reset diode of the plurality of reset diodes.

18. A method of writing data to an electrophoretic flat panel display with memory comprising the steps of:
providing an electrophoretic flat display panel including an active matrix with an array of conductive pads positioned on the reverse side of the flat display panel so that each conductive pad defines a pixel in conjunction with a common transparent conductive electrode positioned on the major viewing surface, the active matrix including select lines and data lines with a data input diode and a storage capacitor connecting each conductive pad to one of the data lines and to one of the select lines, respectively, such that each pixel is separately addressable by a unique combination of select line and data line, and a common reset terminal coupled to the common transparent conductive electrode;
resetting all of the pixels initially into a dark state by applying a V_{EPD}+Vₒₙ signal to the reset terminal, a signal equal to zero volts to all select lines, and a Vₒₙ signal to all data lines, where V_{EPD} is a voltage required to change states of the pixel and Vₒₙ is the turn on voltage of the data input diode; and
writing data into the storage capacitor of a selected pixel by applying a zero voltage signal on the select line of the selected pixel, applying a signal equal to V_{EPD}+Vₒₙ to all select lines of pixels not selected, retaining the signal equal to V_{EPD}+Vₒₙ on the reset terminal, and applying a signal to the data line of a selected pixel equal to a voltage between Vₒₙ and V_{EPD}+Vₒₙ representative of a desired brightness.

19. A method of writing data to an electrophoretic flat panel display with memory comprising the steps of:
providing an electrophoretic flat display panel including an active matrix with an array of conductive pads positioned on the reverse side of the flat display panel so that each conductive pad defines a pixel in conjunction with the electrophoretic flat display panel, a plurality of conductive select lines positioned on the flat display panel, the active matrix including data lines and a common reset terminal, each pixel including a data input diode, a storage capacitor, and a reset diode connecting each conductive pad to one of the data lines, to one of the select lines, and to the common reset terminal, respectively, such that each pixel is separately addressable by a unique combination of select line and data line;
resetting all of the pixels initially into a dark state by applying a zero volt signal to the reset terminal, a signal equal to V_{EPD}+Vₒₙ to all select lines, and a zero volt signal to all data lines, where V_{EPD} is a voltage required to change states of the pixel and Vₒₙ is the turn on voltage of the data input diode; and
writing data into the storage capacitor of a selected pixel by applying a zero voltage signal on the select line of the selected pixel, applying a signal equal to V_{EPD}+Vₒₙ to all select lines of pixels not selected, applying a signal equal to Vₒₙ+2V_{EPD}, to the reset terminal, and applying a signal to the data line equal to a voltage between Vₒₙ and V_{EPD}+Vₒₙ representative of a desired brightness.

20. A method as claimed in claim 19 further including a step of charging the storage capacitor in each pixel to zero volts subsequent to the step of resetting by setting all select lines to zero volts and all data lines to Vₒₙ.
